(19) United States
(12) Patent Application Publication
(10) Pub. No.: US 2026/0346794 A1
(43) Pub. Date: Nov. 5, 2026

(54) HITCH CARRIER

(71) Applicant: CAR MATE MFG. CO., LTD., Tokyo (JP)

(72) Inventors: Hisashi NAKAMURA, Tokyo (JP); Daisuke KISAKA, Tokyo (JP)

(73) Assignee: CAR MATE MFG. CO., LTD., Tokyo (JP)

(21) Appl. No.: 19/206,564

(22) Filed: May 13, 2025

(30) Foreign Application Priority Data
May 24, 2024 (JP) 2024-084865

(51) Int. Cl. B60R 9/06; B60R 9/10

(52) U.S. Cl. CPC B60R 9/06; B60R 9/10

(57) ABSTRACT

A hitch carrier is configured to include a vehicle engaging frame with an angle adjustment mechanism via a hub, a mainframe having a base end side journaled at the angle adjustment mechanism so as to be rotatable and a distal end side on which an operation lever is disposed, a positioning pin that allows the mainframe to move in an axial direction of the mainframe, is biased to the base end side, and determines a tilt position of the mainframe by an engagement in a positioning groove provided in the hub, and a connecting member that connects the operation lever and the positioning pin. The connecting member is configured to move due to a swing motion of the operation lever, and the engagement of the positioning pin into the positioning groove is released.

### TECHNICAL FIELD

The present invention relates to a carrier for carrying cargo, such as bicycles, and in particular to a hitch carrier for carrying cargo at a rear of a vehicle.

### BACKGROUND ART

Various types of carriers (hitch carriers) for carrying cargo, such as bicycles, at a rear of vehicle are known. A typical structure is as disclosed in Patent Document 1, which has a vehicle engaging frame that can be engaged with a hitch receiver (not illustrated) installed at the rear of vehicle, and a mainframe that can be adjusted in angle with respect to the vehicle engaging frame. An example of the hitch carrier with this basic configuration is illustrated in FIGS. 10 and 11.

A hitch carrier 1 disclosed in Patent Document 1 includes a hub 4 as an angle adjustment mechanism interposed between a vehicle engaging frame 2 and a main frame 3. The main frame 3 is configured to be turnable with respect to this hub 4 while a positioning pin 5 is mated into a positioning groove 4a provided in the hub 4, thereby a tilt angle (position) of the main frame 3 is determined. An operation lever 6 is provided at a distal end of the mainframe 3, and this operation lever 6 is connected to the positioning pin 5 by a connecting member 7 located in the mainframe 3. With this configuration, pulling the operation lever 6 toward a distal end side of the mainframe 3 releases the mating of the positioning pin 5 into the positioning groove 4a, allowing the turn of the mainframe 3.

With the hitch carrier 1 in this configuration, the tilt angle of the mainframe 3 can be easily changed simply by operating the operation lever 6 at the distal end of the mainframe 3.

However, in the hitch carrier 1 with this configuration, it is necessary to pull the operation lever 6 along an axial direction (longitudinal direction) of the mainframe 3 when releasing the mated state of the positioning pin 5. Therefore, depending on a length and the tilt angle of the mainframe 3, it may be difficult to apply force when operating the operation lever 6.

### CITATION LIST

### Patent Literature

Patent Document 1: U.S. Pat. No. 11,390,222 B2

### DISCLOSURE OF THE INVENTION

### Problems to be Solved by the Invention

Therefore, an objective of the present invention is to provide a hitch carrier that facilitates a manner of operation of an operation lever and makes it possible to adjust a tilt angle of a mainframe even when it is difficult to apply force.

### Solutions to the problems

To achieve the above-described object, a hitch carrier according to the present invention includes a vehicle engaging frame, a mainframe, a positioning pin, and a connecting member. The vehicle engaging frame has one end on which a coupling portion coupled to a hitch receiver is disposed and another end on which an angle adjustment mechanism via a hub is disposed. The mainframe has a base end side journaled at the angle adjustment mechanism so as to be rotatable and a distal end side on which an operation lever is disposed. The positioning pin allows the mainframe to move in an axial direction of the mainframe, is biased to the base end side, and determines a tilt position of the mainframe by an engagement into a recessed groove provided in the hub. The connecting member connects the operation lever and the positioning pin. The connecting member moves in the axial direction due to a swing motion of the operation lever, and the engagement of the positioning pin into the recessed groove is released by attracting the connecting member to the distal end side.

The preferred operation lever of the hitch carrier with the above-described feature has a fulcrum, a force point, and a point of action. The hitch carrier is configured such that the fulcrum is journaled, and the point of action is moved by swinging the force point in a direction different from the axial direction so as to attract the connecting member. According to this provided feature, a principle of leverage can be applied to the operation lever. Therefore, by making a distance between the fulcrum and the force point longer than a distance between the fulcrum and the point of action, it is possible to perform the attraction of the connecting member with a small force.

In the hitch carrier with the above-described feature, the hitch carrier may be configured such that a handle is provided on the distal end side of the mainframe and the fulcrum of the operation lever is journaled on the distal end side of the mainframe or a frame of the handle. With this provided feature, the swing motion of the operation lever can be performed with one hand by using the handle as a base point to grip the operation lever.

The preferred handle of the hitch carrier with the above-described feature has a tilt angle upward in a mounting orientation with respect to the axial direction in a longitudinal direction of the mainframe. This feature allows the user to avoid having their hands caught between the ground and the mainframe, even when the mainframe is lowered close to the ground with the user's hands on the handle.

The operation lever of the hitch carrier with the above-described feature may be configured to place the point of action between the fulcrum and the force point. Even when the operation lever is in this manner, the principle of leverage as described above can be applied.

### EFFECTS OF THE INVENTION

According to the hitch carrier with the above-described features, the manner of operation of the operation lever can be simplified. This makes it possible to easily operate the operation lever and adjust the tilt angle of the mainframe, even when it is difficult to apply force.

### BRIEF DESCRIPTION OF THE DRAWINGS

FIG. 1 is a view illustrating a side configuration of a hitch carrier according to a first embodiment.

FIG. 2 is a partial sectional side view of the hitch carrier according to the first embodiment in a side view with a case of an angle adjustment mechanism open.

FIG. 3 is a view illustrating a cross-sectional configuration of the hitch carrier according to the first embodiment divided in a longitudinal direction.

FIG. 4 is a perspective view of a partial section of the hitch carrier according to the first embodiment.

FIG. 5 is a partial sectional side view of the hitch carrier according to the first embodiment, illustrating a state in which a mainframe is raised to a maximum angle.

FIG. 6 is a partial sectional side view of the hitch carrier according to the first embodiment, illustrating a state in which the mainframe is lowered to a minimum.

FIG. 7 is a view illustrating a side structure of the hitch carrier according to a second embodiment.

FIG. 8 is a view illustrating a cross-sectional configuration of the hitch carrier according to the second embodiment divided in the longitudinal direction.

FIG. 9 is a partial sectional side view of the hitch carrier according to the second embodiment in a side view with a case of the angle adjustment mechanism open.

FIG. 10 is a view illustrating a side configuration of a conventional hitch carrier.
FIG. 11 is a view illustrating a cross-sectional configuration of a conventional hitch carrier divided in the longitudinal direction.

### DESCRIPTION OF PREFERRED EMBODIMENTS

The following describes embodiments according to a hitch carrier of the present invention in detail with reference to the drawings. The embodiments described below are parts of the preferred configurations in performing the present invention, and even when the appearance shape or the configuration is partially changed, they can be considered to be a part of the present invention insofar as the effect of the present invention is provided.

### First Embodiment: Configuration

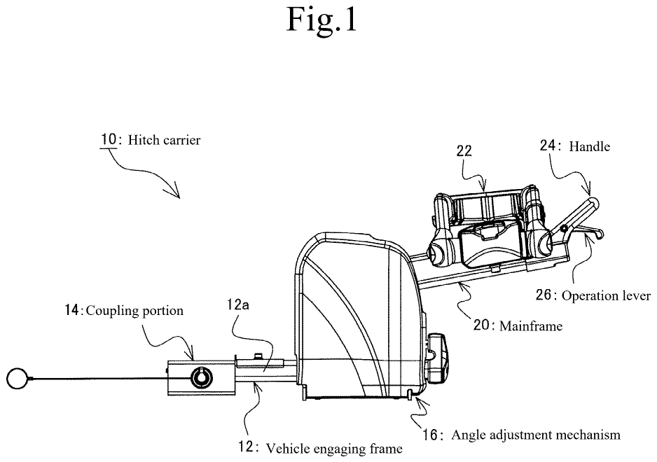

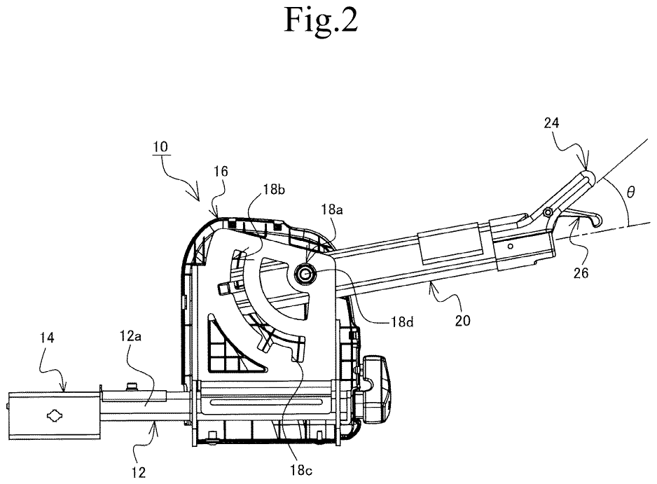

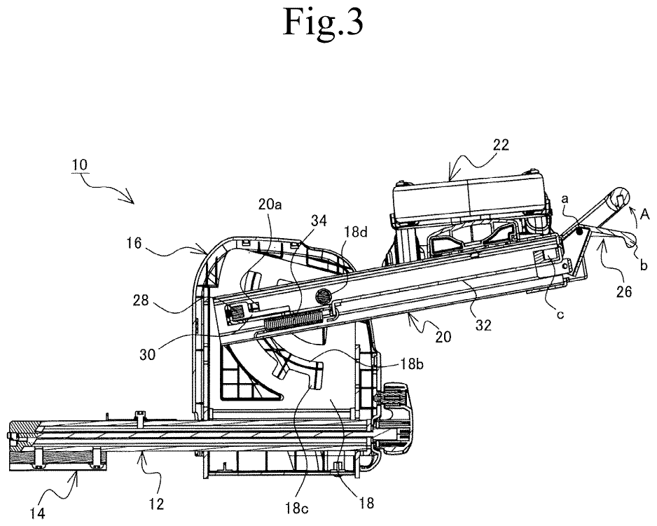

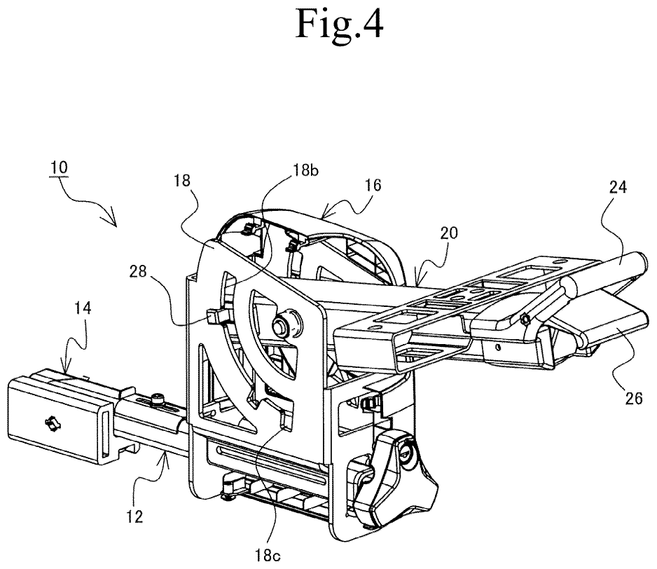

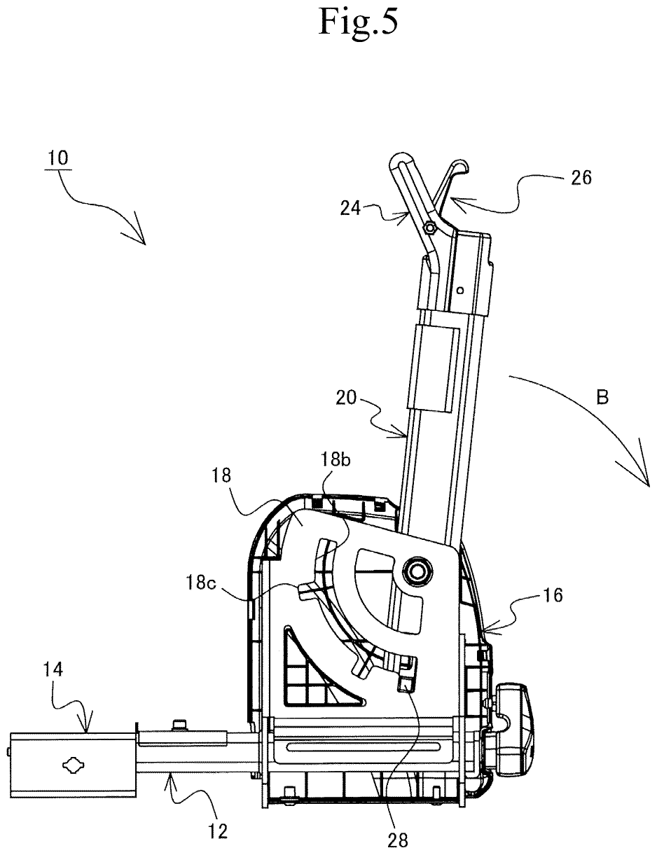

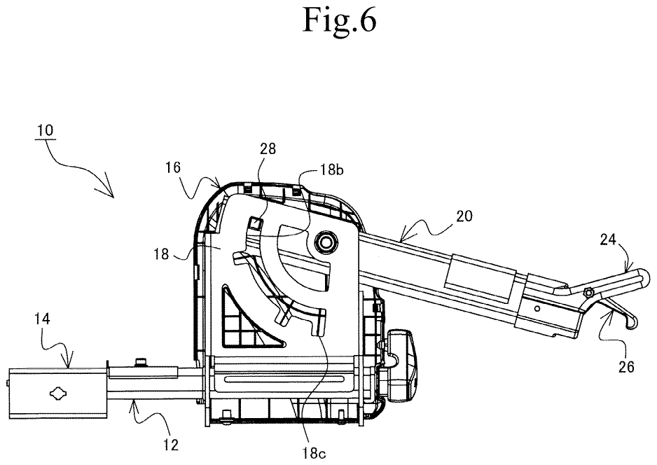

First, with reference to FIG. 1 to FIG. 6, a hitch carrier according to the first embodiment will be described. In the drawings, FIG. 1 is a view illustrating a side configuration of a hitch carrier according to the first embodiment. FIG. 2 is a partial sectional side view of the hitch carrier according to the first embodiment in a side view with a case of an angle adjustment mechanism open. FIG. 3 is a view illustrating a cross-sectional configuration of the hitch carrier according to the first embodiment divided in a longitudinal direction. FIG. 4 is a perspective view of a partial section of the hitch carrier according to the first embodiment. FIG. 5 is a partial sectional side view of the hitch carrier according to the first embodiment, illustrating a state in which a mainframe is raised to a maximum angle. FIG. 6 is a partial sectional side view of the hitch carrier according to the first embodiment, illustrating a state in which the mainframe is lowered to a minimum.

A hitch carrier 10 according to this embodiment is basically configured of a vehicle engaging frame 12, a mainframe 20, a positioning pin 28, and a connecting member 32. The vehicle engaging frame 12 is an element that serves as a base portion for mounting the hitch carrier 10 to a vehicle (not illustrated). Specifically, at one end of a long (a length in the longitudinal direction is sufficiently long compared with a length in a width direction) frame base 12a, a coupling portion 14 to a hitch receiver (not illustrated) provided on a not illustrated vehicle is provided, and at the other end, an angle adjustment mechanism 16 is provided. The coupling portion 14 is not required to describe in detail, as long as it can be securely fixed to the hitch receiver.

As illustrated in FIG. 2, the angle adjustment mechanism 16 is configured to determine a tilt angle of the mainframe 20, described later in detail, by an internally disposed hub 18. The hub 18 is provided with a rotational center hole 18a, an arc-shaped groove 18b, and positioning grooves 18c. The rotational center hole 18a is an element that serves as the rotational center of the mainframe 20, which is described later in detail, and is a part into which a rotation shaft 18d is inserted. The arc-shaped groove 18b is an arc-shaped groove with the rotational center hole 18a as a base point and is an element for moving the positioning pin 28, which is described later in detail. The positioning grooves 18c are grooves formed to protrude on an outer peripheral side of the arc-shaped groove 18b and are provided radially at multiple positions of the arc-shaped groove 18b with the rotational center hole 18a as the base point. Mating of the positioning pin 28 into the positioning groove 18c can avoid the turn of the mainframe 20, thereby determining the tilt angle of the mainframe 20.

The mainframe 20 is an element that serves as a cargo bed of the hitch carrier 10, on which a cradle 22 is disposed when a bicycle is mounted. The mainframe 20 is configured to have the tilt angle changeable with the angle adjustment mechanism 16 described above as the base point. The mainframe 20 is configured of a hollow material, provided with the rotation shaft 18d at the rotational center, and also provided with a handle 24 and an operation lever 26 at an end part (tip) projecting from the angle adjustment mechanism 16. Also, the mainframe 20 is provided with a rectangular hole 20a having a long axis along the longitudinal direction, and the positioning pin 28 is disposed in the rectangular hole 20a. By moving the positioning pin 28 along the long axis direction of the rectangular hole 20a, the mainframe 20 can be switched between a tilt angle positioning state and a turnable state.

The handle 24 is disposed to extend diagonally upward in a side view of the mainframe 20. This arranged configuration makes it possible to avoid a situation in which a hand grasping the handle 24 contacts the ground or the like (a hand is caught between the ground and the mainframe 20) when the tilt angle of the mainframe 20 is lowered with the handle 24 grasped. The tilt angle θ of the handle 24 is not limited but is preferably tilted upward by about 30 degrees from an extended line of the mainframe 20.

The operation lever 26 has a rotation shaft that serves as a fulcrum a on the frame of the handle 24, and has a force point b and a point of action c. With the configuration of the operation lever 26 in this manner, adjusting distances between the fulcrum a, the force point b, and the point of action c allows adjusting a force applied at the point of action c through the operation of the force point b, making it possible to generate a large force at the point of action c with a small force.

The positioning pin 28 is fixed to a pin base 30, which is movable in parallel along the longitudinal direction in an internal space of the mainframe 20, and is disposed to have a part projecting outside from the rectangular hole 20a. The shape of the positioning pin 28 is not specifically limited, and it is only necessary that the positioning pin 28 is movable along the arc-shaped groove 18b provided in the hub 18 and the tilt angle of the mainframe 20 can be fixed by fitting the positioning pin 28 into the positioning groove 18c.

A connecting member 32 is disposed between the point of action c of the operation lever 26 and the pin base 30. By operating the force point b of the operation lever 26 (by swinging in a direction of an arrow A), the point of action c turns around the fulcrum a and the connecting member 32 is attracted to distal end side of the mainframe 20, making it possible to attract the pin base 30. Here, the pin base 30 according to this embodiment is given a force attracting to the base end side of the mainframe 20 through biasing means 34. This configuration makes it possible to avoid the positioning pin 28 unintentionally slipping out of the positioning groove 18c.

In this embodiment, it is described that the fulcrum a of the operation lever 26 is fixed on the frame of the handle 24 (the rotation shaft is arranged). However, needless to say, the fulcrum a may be located on the distal end side of the mainframe 20, depending on the operability of the operation lever 26, the form of the handle 24, and the like.

### Action and Effects

Next, the operation of the hitch carrier 10 having the above-described configuration will be described. As illustrated in FIG. 2, FIG. 5, and FIG. 6, the hitch carrier 10 according to this embodiment allows the turn of the mainframe 20 to change the tilt angle having the rotation shaft 18d disposed at the hub 18 provided in the angle adjustment mechanism 16 as the base point.

For example, in the state illustrated in FIG. 5, the positioning pin 28 is mated into the positioning groove 18c provided at the lowest side of the arc-shaped groove 18b and the mainframe 20 is in a standing state (not functioning as a cargo bed: an unused state). From this state, by operating (swinging) the operation lever 26 so as to be gripped toward the handle 24 side while grasping the handle 24, the mating of the positioning pin 28 into the positioning groove 18c is released and the mainframe 20 can be turned in a direction of an arrow B.

The pin base 30, to which the positioning pin 28 is fixed, is biased to the base end side of the mainframe 20 by the biasing means 34. Therefore, it is not necessary to operate the operation lever 26 while the mating of the positioning pin 28 into the positioning groove 18c is released by the operation of the operation lever 26 and the positioning pin 28 is moving along the arc-shaped groove 18b as the mainframe 20 is turned. When the positioning pin 28 moves to a position corresponding to another positioning groove 18c, the positioning pin 28 is mated into the corresponding positioning groove 18c. In the state illustrated in FIG. 2, the positioning pin 28 is mated into the positioning groove 18c provided at the highest position among a plurality of positioning grooves arranged along the arc-shaped groove 18b.

As for the mainframe 20, as illustrated in FIG. 6, the distal end position can also be further lowered from the tilt position illustrated in FIG. 2 by operating the operation lever 26 to release the mated state of the positioning pin 28. In the state illustrated in FIG. 6, the positioning pin 28 contacts the upper end of the arc-shaped groove 18b, stopping the turn of the mainframe that attempts to rotate in the direction of lowering the tip due to its own weight.

Thus, in the hitch carrier 10 according to this embodiment, the mainframe 20 is rotatable using the rotation shaft 18d as the base point. Also, in a case where a plurality of the positioning grooves 18c are provided, the tilt angle can be fixed according to the position of the positioning groove 18c.

Furthermore, the operation of the operation lever 26 at the distal end of the mainframe 20 makes the turning operation of the mainframe 20 possible. The manner of operation of the operation lever 26 is a swing type, which enables easy operation of the operation lever 26 even when it is difficult to apply force to the operation of the operation lever 26 due to the tilt angle or length of the mainframe 20. Thus, the tilt angle of the mainframe 20 can be adjusted easily.

Furthermore, by providing the operation lever 26 with the fulcrum a, the force point b, and the point of action c and making the principle of leverage applicable, it is also possible to reduce the force required for the swing operation of the operation lever 26 by changing ratios between the fulcrum a and the force point b, and between the fulcrum a and the point of action c.

### Second Embodiment: Configuration

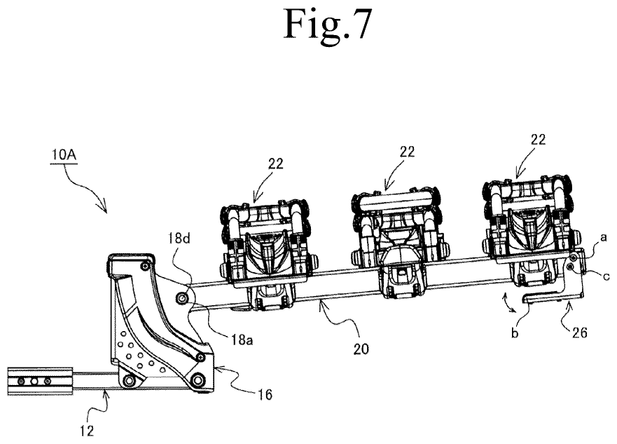

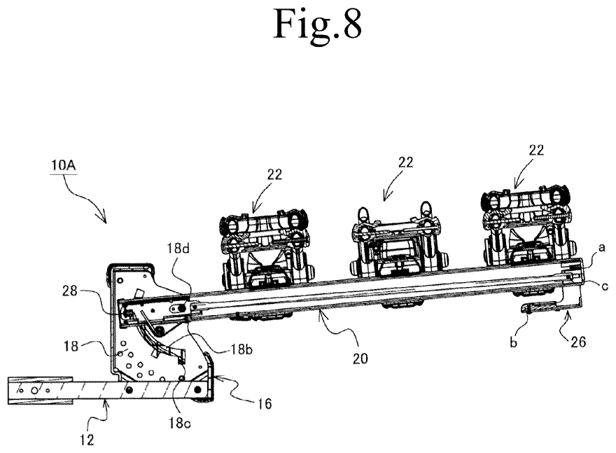

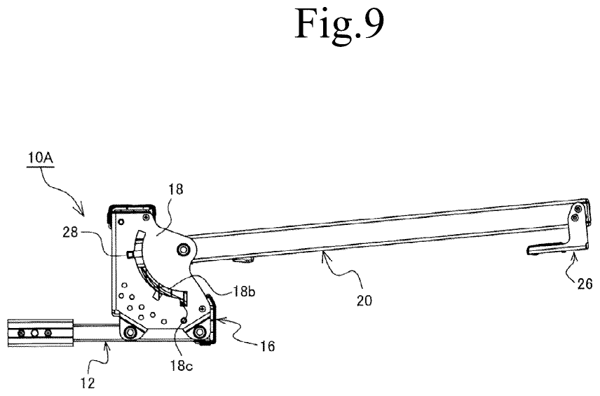

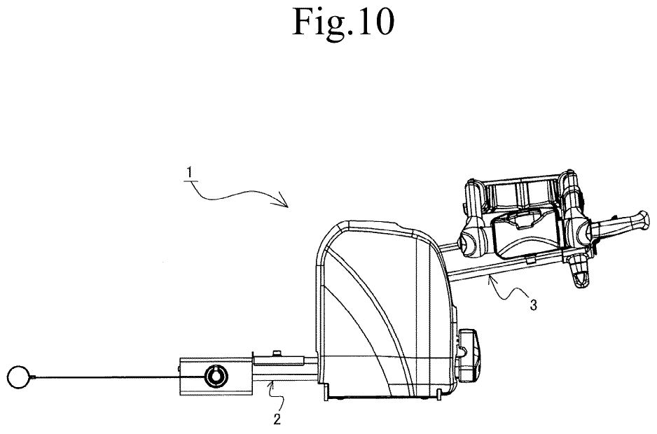

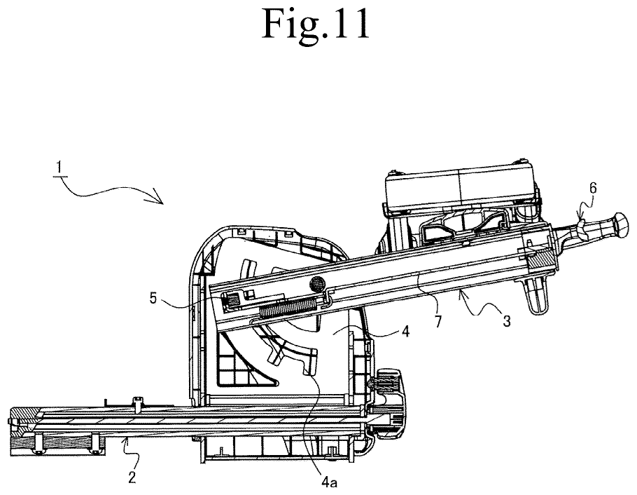

Next, with reference to FIG. 7 to FIG. 9, a hitch carrier according to the second embodiment will be described. A hitch carrier 10A according to this embodiment also has the basic configuration similar to that of the hitch carrier 10 according to the first embodiment. That is, the hitch carrier 10A is basically configured of the vehicle engaging frame 12, the mainframe 20, the positioning pin 28, and the connecting member 32. The mainframe 20 allows turning motion using the angle adjustment mechanism 16 provided at the other end of the vehicle engaging frame 12 as the base point. An operation lever 26 is disposed at the distal end of the mainframe 20, and the positioning pin 28 and the point of action c of the operation lever 26 are coupled by the connecting member 32. Therefore, by the swing operation of the operation lever 26, the positioning pin 28 is pulled out from the positioning groove 18c of the hub 18 in the angle adjustment mechanism 16, making the turning operation of the mainframe 20 possible.

The hitch carrier 10A according to this embodiment is different from the hitch carrier 10 according to the first embodiment in that the handle 24 at the distal end of the mainframe 20 is eliminated and the operation lever 26 is L-shaped to arrange the force point b in a direction along the mainframe 20. In such a configuration, the point of action c is placed between the force point b and the fulcrum a in the operation lever 26. In addition, by making the operation lever 26 L-shaped and arranging the force point b in the direction along the mainframe 20, it is facilitated to input a force at the operation of the operation lever 26 even without the handle 24.

The hitch carrier 10A in this configuration is also similar to the hitch carrier 10 of the first embodiment described above in terms of the effects thereof.

### DESCRIPTION OF REFERENCE SIGNS

10, 10A Hitch carrier

12 Vehicle engaging frame

12a Frame base

14 Coupling portion

16 Angle adjustment mechanism

18 Hub

18a Rotational center hole

18b Arc-shaped groove

18c Positioning groove

18d Rotation shaft

20 Mainframe

20a Rectangular hole

22 Cradle

24 Handle

26 Operation lever

28 Positioning pin

30 Pin base

32 Connecting member

34 Biasing means

1. A hitch carrier comprising:
a vehicle engaging frame having one end on which a coupling portion coupled to a hitch receiver is disposed and another end on which an angle adjustment mechanism via a hub is disposed;
a mainframe having a base end side journaled at the angle adjustment mechanism so as to be rotatable and a distal end side on which an operation lever is disposed;
a positioning pin that allows the mainframe to move in an axial direction of the mainframe, is biased to the base end side, and determines a tilt position of the mainframe by an engagement into a recessed groove provided in the hub; and
a connecting member that connects the operation lever and the positioning pin, wherein
the connecting member moves in the axial direction due to a swing motion of the operation lever, and the engagement of the positioning pin into the recessed groove is released by attracting the connecting member to the distal end side.

2. The hitch carrier according to claim 1, wherein
the operation lever has a fulcrum, a force point, and a point of action, and
the hitch carrier is configured such that the fulcrum is journaled and the point of action is moved by swinging of the force point in a direction different from the axial direction so as to attract the connecting member.

3. The hitch carrier according to claim 2, wherein
a handle is provided on the distal end side of the mainframe, and
the fulcrum of the operation lever is journaled on the distal end side of the mainframe or a frame of the handle.

4. The hitch carrier according to claim 3, wherein
the handle has a tilt angle upward in a mounting orientation with respect to the axial direction in a longitudinal direction of the mainframe.

5. The hitch carrier according to claim 2, wherein
the operation lever is configured to place the point of action between the fulcrum and the force point.
